(19) United States
(12) Patent Application Publication
(10) Pub. No.: US 2026/0111136 A1
(43) Pub. Date: Apr. 23, 2026

(54) READ DISTURB SCANS REPETITIVE PARTIAL BLOCK FOLDING

(71) Applicant: Micron Technology, Inc., Boise, ID (US)

(72) Inventors: Wenchi Hong, Taichung City (TW); Tingjun Xie, Milpitas, CA (US)

(21) Appl. No.: 18/921,793

(22) Filed: Oct. 21, 2024

(51) Int. Cl. G06F 11/10; G06F 11/07

(52) U.S. Cl. CPC G06F 11/1016; G06F 11/076; G06F 11/1068

(57) ABSTRACT

This disclosure is directed to a system for performing read error handling. The system receives a first request to read data from a first word line (WL) of a block stripe (BS) stored on the memory device and determines that the request to read the data triggers a read error handling operation. The system, in response to determining that the request to read the data triggers the read error handling operation, folds a first portion of data stored in the BS including data stored in the first WL and repetitively performs a plurality of additional folding operations for data remaining in the BS upon receiving additional requests to read data stored in the BS.

### TECHNICAL FIELD

Examples of the disclosure relate generally to memory sub-systems and, more specifically, to performing read error handling (REH) operations.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 is a block diagram of a storage management component, in accordance with some examples.

FIG. 3 illustrates a diagram of operations performed using the storage management component, in accordance with some examples.

FIG. 4 illustrates a flow diagram of a method or process, according to some examples.

FIG. 5 illustrates a flow diagram of a method or process, according to some examples.

FIG. 6 is a block diagram of an example computer system, according to some examples.

### DETAILED DESCRIPTION

The present disclosure is directed to a system including a memory device and a processing device, operatively coupled to the memory device, configured to perform operations that improve REH, such as in the case of read disturb (RD) errors detected by performing RD handling (RDH) scans. Specifically, the disclosed processing device receives a request to read data from an individual word line (WL) of a block stripe (BS). The processing device folds some of the data stored in the BS in response to determining that the request to read the data triggers a REH operation (e.g., the read bit error rate (RBER) computed based on the request transgresses a threshold RBER). The processing device then performs additional folding operations (e.g., additional partial block folding operations) on data that remains in the BS as additional requests to read data stored in the BS are received. Namely, rather than performing a partial block folding operation on some of the data stored in the BS when an initial triggering of the REH operation following by the rest of the data stored in the BS when a read counter reaches a threshold, the processing device repetitively and continuously folds the data using partial folding operations. This avoids having a large amount of data folded at one time (e.g., when the read counter reaches the threshold), which can significantly enhance the overall operations of the memory sub-system, such as by improving storage efficiency and performance.

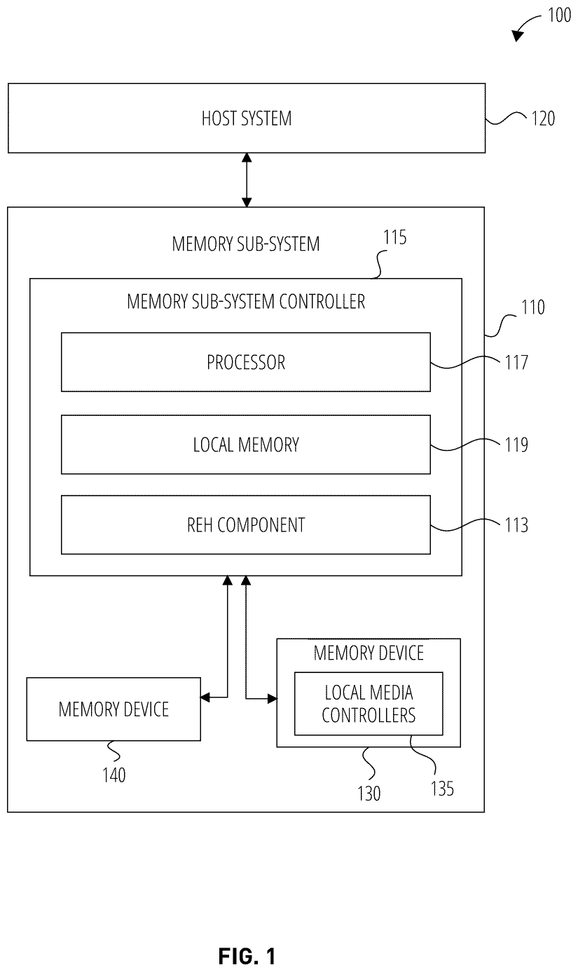

A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command, erase command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of garbage collection (GC) management operations. The data that is rewritten, for example as initiated by the firmware, is hereinafter referred to as “GC data.” Examples of system data include, but are not limited to, system tables (e.g., logical-to-physical memory address mapping table, also referred to herein as a logical-to-physical (L2P) mapping table (referred to as an L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package. The memory device can be divided into one or more zones where each zone is associated with a different set of host data or user data or application.

Certain memory devices, such as NAND-type memory devices, comprise one or more blocks, (e.g., multiple blocks), with each of those blocks comprising multiple memory cells. For instance, a memory device can comprise multiple pages (also referred to as word lines (WLs)), with each page comprising a subset of memory cells of the memory device. A threshold voltage (VT) of a memory cell (of a block) can be the voltage at which the floating gate (e.g., NAND transistor), implementing the memory cell, turns on and conducts (e.g., to a bit line coupled to the memory cell). Generally, writing data to such memory devices involves programming (by way of a program operation) the memory devices at the page level of a block, and erasing data from such memory devices involves erasing the memory devices at the block level (e.g., page level erasure of data is not possible).

Conventional RDH operations in memory sub-systems typically employ a physical to logical (P2L)-based folding approach for initial partial BS folding followed by a priority BS-based folding operation. In this process, a BS is partially folded, leaving a significant portion of data unfolded when a RDH condition (or other REH condition) is met or satisfied. The memory sub-system then waits for a predetermined number of read operations before completing the folding process for the remaining data stored in the block stripe. This method, while intended to address read disturb issues, introduces several inefficiencies. The partial folding can leave a substantial amount of data vulnerable to read disturb effects, potentially compromising data integrity. The delay in completing the folding process can result in suboptimal system performance and resource utilization. Moreover, the high volume of remaining unfolded data can significantly slow down subsequent RDH operations when the memory sub-system finally decides to complete the folding process (e.g., when a threshold number of additional read requests to the BS is received). This conventional approach leads to increased complexity in managing partially folded BSs, inconsistent performance, and potential increases in latency and wear on the storage media. Ultimately, these inefficiencies collectively contribute to slower and less effective RDH operations, particularly when dealing with large amounts of remaining data.

The present disclosure addresses these inefficiencies by implementing a more proactive and comprehensive folding approach. Upon receiving a request to read data from a specific WL in a BS that triggers a REH operation, the disclosed techniques immediately initiate a folding process for a portion of the data, including the specific WL. This initial folding operation is followed by a series of additional folding operations for the remaining data in the BS, executed in conjunction with subsequent read requests. This approach eliminates the delay associated with waiting for a predetermined number of read operations before completing the folding process. By folding data more frequently and in smaller portions, the disclosed techniques reduce the amount of vulnerable data at any given time, potentially improving data integrity and system performance. The repetitive folding operations for remaining data allow for a more dynamic and adaptive approach to RDH, potentially reducing latency and improving overall efficiency of the memory sub-system compared to the conventional method of partial folding followed by a delayed completion of the process.

In some examples, the techniques described herein relate to a system having a processing device, operatively coupled to a memory device. The processing device is configured to receive a first request to read data from a first WL of a BS stored on the memory device and determine that the request triggers a REH operation. In response, the processing device folds a first portion of data stored in the BS, including data stored in the first WL, and repetitively performs additional folding operations for data remaining in the BS upon receiving further requests to read data stored in the BS. In some cases, the REH operations involve a RDH operation. The processing device can receive a second request to read data from a second WL of the BS and can fold a second portion of data stored in the BS, including data stored in the second WL, without folding a third portion of data stored in the BS. Upon receiving a third request to read data from a third WL, the processing device folds the third portion of data stored in the BS, including data stored in the third WL.

In some instances, the processing device determines or identifies a set of high-risk WLs within the BS based on historical read disturb data and includes these high-risk WLs in the first portion of data to be folded during the REH operation. The processing device may randomly select one of a set of adjacent WLs for each additional folding operation performed in response to further read requests. The processing device can also select physical storage locations including data stored in a set of high-risk WLs within the BS, one or more adjacent WLs to the first WL, and the first WL to include as part of the first portion of data that is folded.

In some examples, upon receiving a second request to read data from a second WL of the BS, the processing device randomly selects an adjacent WL of a set of WLs adjacent to the second WL and determines whether the selected adjacent WL triggers the REH operation. If the selected adjacent WL triggers the REH operation, the processing device selects additional physical storage locations including additional data stored in the set of WLs adjacent to the second WL and the second WL to include as part of a second portion of data that is folded, and then folds the second portion of the data stored in the BS. The processing device reads one or more pages of data stored in the selected WL and determines that a RBER resulting from reading the one or more pages of data transgresses a threshold RBER.

In some cases, upon receiving a second request to read data from a second WL of the BS, the processing device randomly selects an adjacent WL of a set of WLs adjacent to the second WL and a new high-risk WL of a new set of high-risk WLs, and determines whether the selected adjacent WL or the selected new high-risk WL triggers the REH operation. If either triggers the REH operation, the processing device selects additional physical storage locations including additional data stored in the set of WLs adjacent to the second WL, the second WL, and the new set of high-risk WLs to include as part of a second portion of data that is folded, and then folds the second portion of the data stored in the BS. The processing device updates a current set of high-risk WLs remaining in portions of the BS that have yet to be folded.

In some instances, upon receiving a third request to read data from a third WL of the BS, the processing device randomly selects an additional adjacent WL of an additional set of WLs adjacent to the third WL and an individual high-risk WL of the current set of high-risk WLs, and determines whether the selected adjacent WL of the additional set of WLs or the selected individual high-risk WL triggers the REH operation. If either triggers the REH operation, the processing device selects a new set of physical storage locations including a set of data stored in the additional set of WLs adjacent to the third WL, the third WL, and the current set of high-risk WLs to include as part of a third portion of data that is folded, and then folds the third portion of the data stored in the BS.

In some examples, folding the first portion of the data involves performing an individual P2L folding operation, and each of the additional folding operations involves performing an additional P2L folding operation. The system can include a three-dimensional (3D) NAND device.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single level cells (SLCs), can store one bit per cell. Other types of memory cells, such as multi-level cells (MLCs), tri-level cells (TLCs), quad-level cells (QLCs), and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or BSs. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data (e.g., performing GC operations) at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, error detection and ECC operations, encryption operations, caching operations, and address translations between a logical address (e.g., LBA, namespace) and a physical memory address (e.g., physical block address in a physical address space of the memory device 130 or memory device 140) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (MNAND) device. Any operation discussed as being performed by the memory sub-system controller 115 can be similarly performed by the local media controllers 135 and vice versa.

The memory sub-system controller 115 includes a REH component 113 that enables or facilitates the memory sub-system controller 115 to implement a more proactive and comprehensive folding approach than conventional systems. Upon receiving a request to read data from a specific WL in a BS that triggers a REH operation, the REH component 113 immediately initiates a folding process for a portion of the data, including the specific WL. This initial folding operation is followed by a series of additional folding operations for the remaining data in the BS, executed in conjunction with subsequent read requests. This approach eliminates the delay associated with waiting for a predetermined number of read operations before completing the folding process. By folding data more frequently and in smaller portions, the REH component 113 reduces the amount of vulnerable data at any given time, potentially improving data integrity and system performance. The repetitive folding operations for remaining data allow for a more dynamic and adaptive approach to RDH, potentially reducing latency and improving overall efficiency of the memory sub-system 110 compared to the conventional method of partial folding followed by a delayed completion of the process.

Any discussion with respect to the memory device 130 can similarly be applied to the memory device 140.

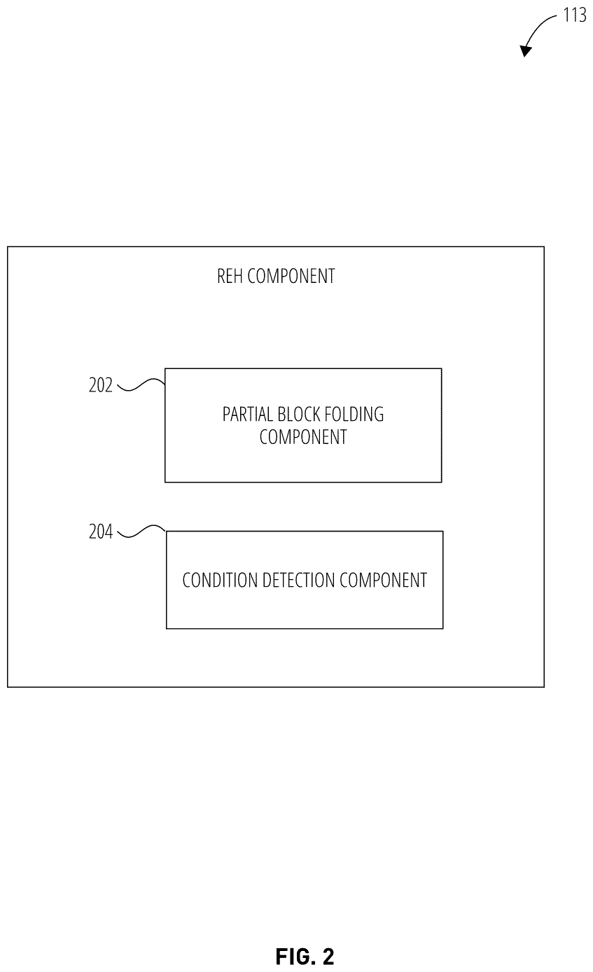

FIG. 2 is a block diagram of a REH component 113, in accordance with some examples. The REH component 113 can include a partial block folding component 202 and/or a condition detection component 204. Specifically, the REH component 113 includes several subcomponents (e.g., the partial block folding component 202 and the condition detection component 204) that work together to improve the operations of the memory sub-system 110. The REH component 113 is designed to improve the efficiency and performance of REH operations in the memory sub-system 110.

The partial block folding component 202 can be responsible for performing folding operations on data stored in one or more BSs of the memory device 130. Specifically, this component can initiate a folding process for a portion of the data, including the specific WL that triggered the REH operation (as determined by the condition detection component 204). The partial block folding component 202 can repetitively perform additional folding operations for the remaining data in the BS upon receiving further requests to read data stored in the BS. This approach ensures that data is folded more frequently and in smaller portions, reducing the amount of vulnerable data at any given time and potentially improving data integrity and system performance.

The condition detection component 204 can be responsible for determining when a REH operation should be triggered, such as when a RDH operation or condition is met. This condition detection component 204 monitors read requests and evaluates whether the request to read data from a specific WL triggers a REH operation, such as a RDH operation. The condition detection component 204 can determine if the RBER resulting from reading the data transgresses a threshold RBER, thereby triggering the REH operation.

For example, the condition detection component 204 can receive a request from a host or other system component to read data stored in a BS, such as a first WL of the BS. In response, the condition detection component 204 can read the data from the first WL of the BS and perform one or more operations to determine whether the first WL satisfies a REH condition. In some cases, the condition detection component 204 determines whether the first WL and/or one or more adjacent WLs of the first WL have an associated RBER that transgresses a threshold. In such cases, the condition detection component 204 determines that the first WL fails a RD scan. In some examples, the condition detection component 204 also determines whether one or more high-risk WLs in the BS have an associated RBER that transgresses the threshold. In such cases, the condition detection component 204 determines that the first WL fails the RD scan. The condition detection component 204 can access configuration data associated with the memory sub-system 110 to obtain a list of all WLs indicated to be high risk. The condition detection component 204 selects a portion of the WLs in the list that correspond to the BS being read. The condition detection component 204 can then select randomly one or more WLs from the portion of the WLs to test the RBER of the data stored in the randomly selected one or more WLs. Any such WL for which the RBER transgresses the threshold RBER can trigger failure of the RD scan and subsequent folding operations.

For example, the condition detection component 204 can inform the partial block folding component 202 that the request to read the first WL failed the RD scan triggering one or more folding operations. The partial block folding component 202 can then select a portion of the BS that includes the first WL for partial folding, such as by performing a P2L folding operation. Namely, the partial block folding component 202 can perform an initial folding operation for the BS by folding the portions of high-risk WLs in the BS that are identified using the list of high-risk WLs, folding the first WL being read (e.g., referred to as the attacked WL), and the two WLs that are adjacent to the first WL (e.g., the adjacent WLs).

After completing this folding operation, the BS can include a remaining set of data in a remaining set of WLs that has yet to be folded. The condition detection component 204 can receive a subsequent request to read data from one or more of the remaining set of WLs, such as from a second WL (e.g., WL(n)). In response, the condition detection component 204 can randomly select an individual adjacent WL from the two WLs that are adjacent to the second WL and can test the selected individual adjacent WL to determine whether the selected individual adjacent WL triggers a REH condition. For example, the condition detection component 204 can determine whether data stored and read from the selected individual adjacent WL is associated with a RBER that transgresses a threshold RBER. In such cases, the condition detection component 204 instructs the partial block folding component 202 to again perform a partial folding operation based on the second WL.

The partial block folding component 202 can then select a portion of the BS that includes the second WL for partial folding, such as by performing an additional P2L folding operation. Namely, the partial block folding component 202 can perform an additional partial folding operation for the BS by folding the second WL being read and the two WLs that are adjacent to the second WL. The partial block folding component 202 can exclude from the additional folding operation the high-risk WLs as those high-risk WLs were all folded as part of the initial folding operation. These operations continue until all of the data in the BS has been folded using the partial folding operations. For example, the condition detection component 204 can receive a subsequent request to read data from one or more of the remaining set of WLs, such as from a third WL. In response, the condition detection component 204 can randomly select a particular adjacent WL from the two WLs that are adjacent to the third WL and can test the selected particular adjacent WL to determine whether the selected particular adjacent WL triggers a REH condition. For example, the condition detection component 204 can determine whether data stored and read from the selected particular adjacent WL (adjacent to the third WL) is associated with a RBER that transgresses a threshold RBER. In such cases, the condition detection component 204 instructs the partial block folding component 202 to again perform a partial folding operation based on the third WL. The partial block folding component 202 can then select a portion of the BS that includes the third WL for partial folding, such as by performing an additional P2L folding operation. Namely, the partial block folding component 202 can perform an additional partial folding operation for the BS by folding the third WL being read and the two WLs that are adjacent to the third WL.

In some cases, rather than folding all of the high-risk WLs in the BS as part of the initial partial folding operation, the partial block folding component 202 can only fold a specified subset of the high-risk WLs of the BS. For example, the condition detection component 204 can receive a request from a host or other system component to read data stored in a BS, such as the first WL of the BS. In response, the condition detection component 204 can read the data from the first WL of the BS and perform one or more operations to determine whether the first WL satisfies a REH condition. In some cases, the condition detection component 204 determines whether the first WL and/or one or more adjacent WLs of the first WL have an associated RBER that transgresses a threshold. In such cases, the condition detection component 204 determines that the first WL fails a RD scan. In some examples, the condition detection component 204 also determines whether one or more high-risk WLs in the BS have an associated RBER that transgresses the threshold. In such cases, the condition detection component 204 determines that the first WL fails the RD scan. The condition detection component 204 can access configuration data associated with the memory sub-system 110 to obtain a list of all WLs indicated to be high risk. The condition detection component 204 selects a portion of the WLs in the list that correspond to the BS being read. The condition detection component 204 can then randomly select one or more WLs from the portion of the WLs to test the RBER of the data stored in the randomly selected one or more WLs. Any such WL for which the RBER transgresses the threshold RBER can trigger failure of the RD scan and subsequence folding operations.

For example, the condition detection component 204 can inform the partial block folding component 202 that the request to read the first WL failed the RD scan triggering one or more folding operations. The partial block folding component 202 can then select a portion of the BS that includes the first WL for partial folding, such as by performing a P2L folding operation. Namely, the partial block folding component 202 can perform an initial folding operation for the BS by folding a first subset of high-risk WLs in the BS that are identified using the list of high-risk WLs, folding the first WL being read (e.g., referred to as the attacked WL), and the two WLs that are adjacent to the first WL (e.g., the adjacent WLs). The partial block folding component 202 can provide to the condition detection component 204 a current set of high-risk WLs that includes all of the remaining high-risk WLs in the BS excluding the first subset of high-risk WLs.

After completing this folding operation, the BS can include a remaining set of data in a remaining set of WLs that has yet to be folded. The condition detection component 204 can receive a subsequent request to read data from one or more of the remaining set of WLs, such as from a second WL (e.g., WL(n)). In response, the condition detection component 204 can randomly select an individual adjacent WL from the two WLs that are adjacent to the second WL and can test the selected individual adjacent WL to determine whether the selected individual adjacent WL triggers a REH condition. For example, the condition detection component 204 can determine whether data stored and read from the selected individual adjacent WL is associated with a RBER that transgresses a threshold RBER. The condition detection component 204 can also randomly select a high-risk WL from the current set of high-risk WLs that are still included in the BS. The condition detection component 204 can determine whether the selected high-risk WL includes data that triggers the REH condition (e.g., the data has an associated RBER that transgresses the RBER threshold). In such cases, the condition detection component 204 instructs the partial block folding component 202 to again perform a partial folding operation based on the second WL.

The partial block folding component 202 can then select a portion of the BS that includes the second WL for partial folding, such as by performing an additional P2L folding operation. Namely, the partial block folding component 202 can perform an additional partial folding operation for the BS by folding the second WL being read and the two WLs that are adjacent to the second WL and a second set of high-risk WLs selected from the current set of high-risk WLs. The partial block folding component 202 can again update the current set of high-risk WLs to remove the selected second set of high-risk WLs so that the current set of high-risk WLs always represents those high-risk WLs that remain in the BS and are yet to be folded.

These operations continue until all of the data in the BS has been folded using the partial folding operations. For example, the condition detection component 204 can receive a subsequent request to read data from one or more of the remaining set of WLs, such as from a third WL. In response, the condition detection component 204 can randomly select a particular adjacent WL from the two WLs that are adjacent to the third WL and a randomly selected high-risk WL from the current set of high-risk WLs and can test the selected particular adjacent WL and the randomly selected high-risk WL to determine whether the selected WLs triggers a REH condition. If so, the condition detection component 204 instructs the partial block folding component 202 to again perform a partial folding operation based on the third WL. The partial block folding component 202 can then select a portion of the BS that includes the third WL for partial folding, such as by performing an additional P2L folding operation. Namely, the partial block folding component 202 can perform an additional partial folding operation for the BS by folding the third WL being read and the two WLs that are adjacent to the third WL and a third set of high-risk WLs selected from the current set of high-risk WLs.

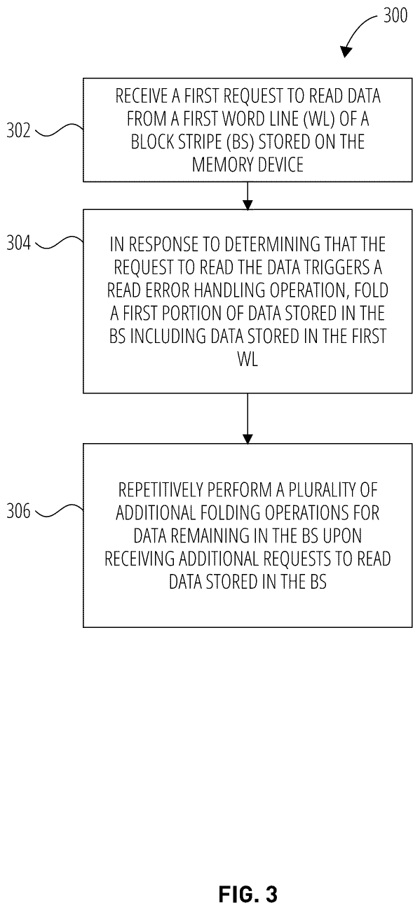

FIG. 3 is a flow diagram of an example diagram 300 (method or process) performed using the REH component 113, in accordance with some examples. The method or process of diagram 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method or process of diagram 300 is performed by the memory sub-system controller 115 or subcomponents of the memory sub-system controller 115 of FIG. 1. In these examples, the method or process of diagram 300 can be performed, at least in part, by the REH component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 3, the method or process of diagram 300 begins at operation 302, with the REH component 113 of a memory sub-system 110 (e.g., memory device 140) receiving a first request to read data from a first WL of a BS stored on the memory device 130. Then, at operation 304, the REH component 113, in response to determining that the request to read the data triggers the REH operation, folds (e.g., performs a P2L folding operation) a first portion of data stored in the BS including data stored in the first WL and, at operation 306 repetitively performs a plurality of additional folding operations (e.g., P2L folding operations) for data remaining in the BS upon receiving additional requests to read data stored in the BS.

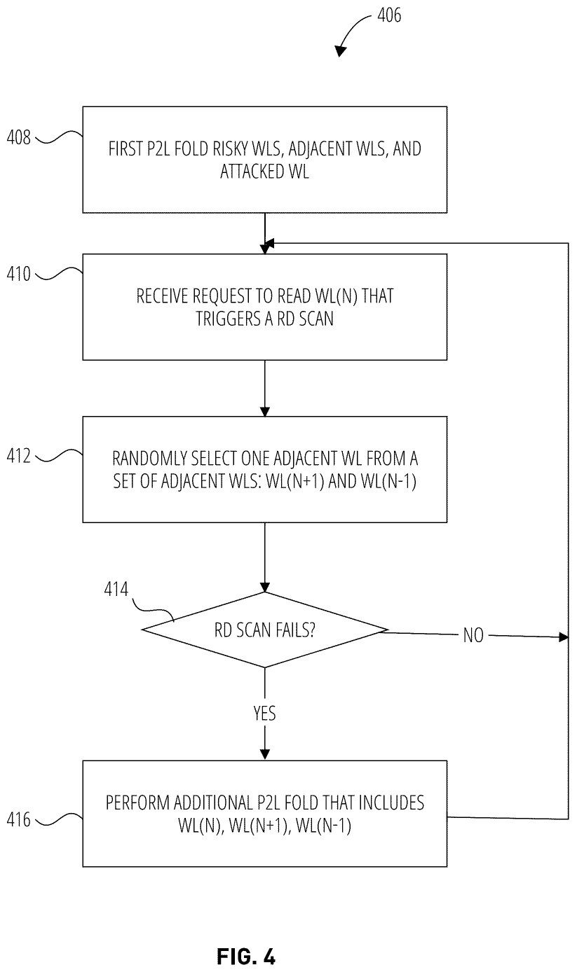

FIG. 4 is a flow diagram of an example diagram 406 (method or process) performed using the REH component 113, in accordance with some examples. The method or process of diagram 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method or process of diagram 406 is performed by the memory sub-system controller 115 or subcomponents of the memory sub-system controller 115 of FIG. 1. In these examples, the method or process of diagram 406 can be performed, at least in part, by the REH component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 4, the method or process of diagram 406 begin at operation 408, with the REH component 113 of a memory sub-system 110 (e.g., memory device 140) performing an initial (first) partial folding operation (P2L fold) on all the high-risk WLs (e.g., risky WLs) in the BS (that includes a WL being read), adjacent WLs to the WL being read, and the attacked WL (e.g., the WL being read). Then, at operation 410, the REH component 113 receives a request to read a WL(N) from the BS which triggers the RD scan operation. The REH component 113, at operation 412, randomly selects an adjacent WL from a set of adjacent WLs (WL(N+1) and WL(N−1)) to the WL(N) being read. At operation 414, the REH component 113 determines whether the selected adjacent WL fails the RD scan, and if so, the REH component 113 performs operation 416 to perform an additional partial folding operation. If not, the REH component 113 performs operation 410. Namely, at operation 416, the REH component 113 folds the attacked WL(N) and the adjacent WLs (WL(N+1), WL(N−1)) excluding high-risk WLs (as those were already folded at operation 408).

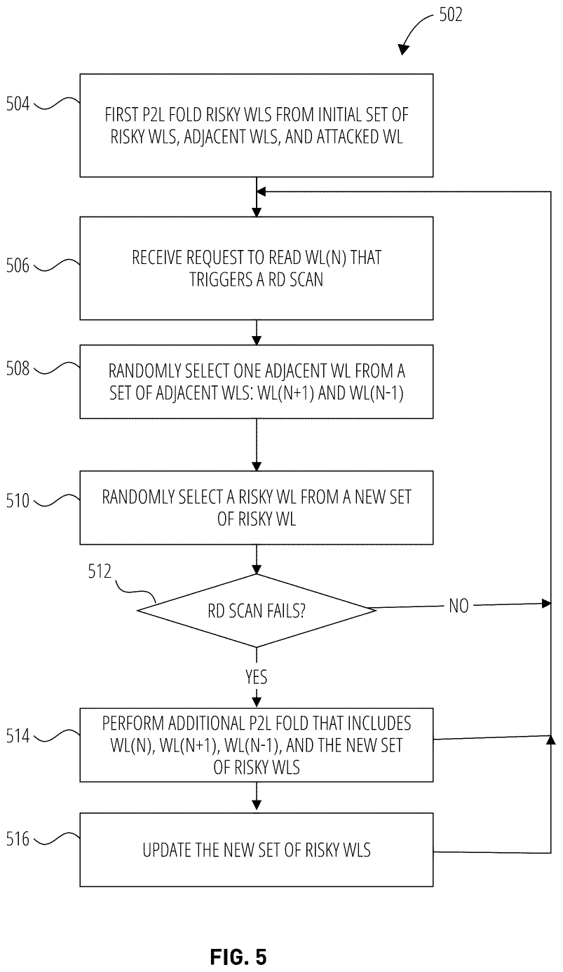

FIG. 5 is a flow diagram of an example diagram 502 (method or process) performed using the REH component 113, in accordance with some examples. The method or process of diagram 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method or process of diagram 502 is performed by the memory sub-system controller 115 or subcomponents of the memory sub-system controller 115 of FIG. 1. In these examples, the method or process of diagram 502 can be performed, at least in part, by the REH component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 5, the method or process of diagram 502 begins at operation 504, with the REH component 113 of a memory sub-system 110 (e.g., memory device 140) performing an initial (first) partial folding operation (P2L fold) on a first subset of the high-risk WLs in the BS (that includes a WL being read), adjacent WLs to the WL being read, and the attacked WL (e.g., the WL being read). Then, at operation 506, the REH component 113 receives a request to read a WL(N) from the BS which triggers the RD scan operation. The REH component 113, at operation 508, randomly selects an adjacent WL from a set of adjacent WLs (WL(N+1) and WL(N−1)) to the WL(N) being read. At operation 510, the REH component 113 randomly selects a high-risk WL from a new set of high-risk WLs that remain in the BS (excluding the first subset of high-risk WLs previously folded). At operation 512, the REH component 113 determines whether the selected WLs fail the RD scan, and if so, the REH component 113 performs operation 514 to perform an additional partial folding operation. If not, the REH component 113 performs operation 506. Namely, at operation 514, the REH component 113 folds the attacked WL(N), the adjacent WLs (WL(N+1) and WL(N−1)), and the new set of high-risk WLs. The REH component 113 then performs operation 516 to update the new set of high-risk WLs to exclude the new set of high-risk WLs, which were folded in operation 514 thereby generating a current set of high-risk WLs remaining in the BS.

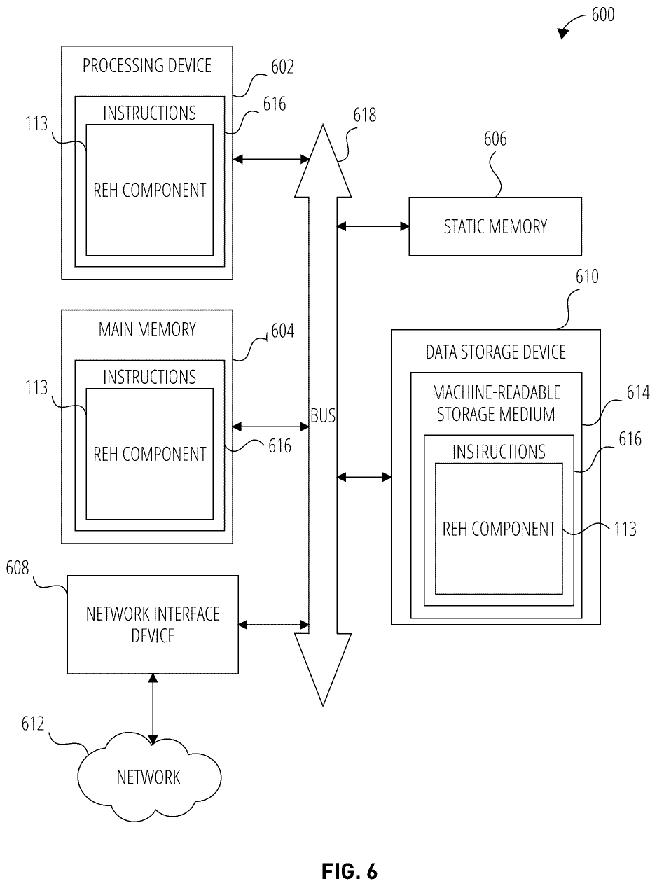

FIG. 6 illustrates an example machine in the form of a computer system 600 within which a set of instructions can be executed for causing the machine to perform any one or more of the methodologies discussed herein. In some examples, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage device 610, which communicate with each other via a bus 618.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application-specific integrated circuit (ASIC), a field programmable gate array (FPGA), a digital signal processor (DSP), a network processor, or the like. The processing device 602 is configured to execute instructions 616 for performing the operations and steps discussed herein. The computer system 600 can further include a network interface device 608 to communicate over a network 612.

The data storage device 610 can include a machine-readable storage medium 614 (also known as a computer-readable medium) on which is stored one or more sets of instructions 616 or software embodying any one or more of the methodologies or functions described herein. The instructions 616 can also reside, completely or at least partially, within the main memory 604 and/or within the processing device 602 during execution thereof by the computer system 600, the main memory 604 and the processing device 602 also constituting machine-readable storage media. The machine-readable storage medium 614, data storage device 610, and/or main memory 604 can correspond to the memory sub-system 110 of FIG. 1.

In one example, the instructions 616 include instructions to implement functionality corresponding to providing block failure protection for a zone memory sub-system as described herein (e.g., the REH component 113 of FIG. 1). While the machine-readable storage medium 614 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1: A system comprising a memory device and a processing device, operatively coupled to the memory device, configured to perform operations comprising receiving a first request to read data from a first word line (WL) of a block stripe (BS) stored on the memory device; determining that the request to read the data triggers a read error handling operation; in response to determining that the request to read the data triggers the read error handling operation, folding a first portion of data stored in the BS including data stored in the first WL; and repetitively performing a plurality of additional folding operations for data remaining in the BS upon receiving additional requests to read data stored in the BS.

Example 2: The system of Example 1, wherein the read error handling operations comprise a read disturb handling (RDH) operation.

Example 3: The system of any of Examples 1-2, the operations comprising receiving a second request to read data from a second WL of the BS stored on the memory device, and folding a second portion of data stored in the BS including data stored in the second WL without folding a third portion of data stored in the BS.

Example 4: The system of any of Examples 1-3, the operations comprising receiving a third request to read data from a third WL of the BS stored on the memory device, and folding the third portion of data stored in the BS including data stored in the third WL.

Example 5: The system of any of Examples 1-4, the operations comprising determining a set of high-risk WLs within the BS based on historical read disturb data, and adding the high-risk WLs in the first portion of data to be folded during the read error handling operation.

Example 6: The system of any of Examples 1-5, the operations comprising randomly selecting one of a set of adjacent WLs for each additional folding operation performed in response to the additional requests to read data stored in the BS.

Example 7: The system of any of Examples 1-6, the operations comprising selecting physical storage locations comprising data stored in a set of high-risk WLs within the BS, one or more adjacent WLs to the first WL, and the first WL to include as part of the first portion of data that is folded.

Example 8: The system of any of Examples 1-7, the operations comprising receiving a second request to read data from a second WL of the BS stored on the memory device, in response to receiving the second request, randomly selecting an adjacent WL of a set of WLs adjacent to the second WL, and determining whether the selected adjacent WL triggers the read error handling operation.

Example 9: The system of any of Examples 1-8, the operations comprising in response to determining that the selected adjacent WL triggers the read error handling operation, selecting additional physical storage locations comprising additional data stored in the set of WLs adjacent to the second WL and the second WL to include as part of a second portion of data that is folded, and folding the second portion of the data stored in the BS.

Example 10: The system of any of Examples 1-9, the operations comprising reading one or more pages of data stored in the selected WL, and determining that a read bit error rate (RBER) resulting from reading the one or more pages of data transgresses a threshold RBER.

Example 11: The system of any of Examples 1-10, the operations comprising receiving a second request to read data from a second WL of the BS stored on the memory device; in response to receiving the second request, randomly selecting an adjacent WL of a set of WLs adjacent to the second WL; in response to receiving the second request, randomly selecting a new high-risk WL of a new set of high-risk WLs; and determining whether the selected adjacent WL or the selected new high-risk WL triggers the read error handling operation.

Example 12: The system of any of Examples 1-11, the operations comprising in response to determining that the selected adjacent WL or the selected new high-risk WL triggers the read error handling operation, selecting additional physical storage locations comprising additional data stored in the set of WLs adjacent to the second WL, the second WL, and the new set of high-risk WLs to include as part of a second portion of data that is folded, and folding the second portion of the data stored in the BS.

Example 13: The system of any of Examples 1-12, the operations comprising updating a current set of high-risk WLs remaining in portions of the BS that have yet to be folded.

Example 14: The system of any of Examples 1-13, the operations comprising receiving a third request to read data from a third WL of the BS stored on the memory device; in response to receiving the third request, randomly selecting an additional adjacent WL of an additional set of WLs adjacent to the third WL; in response to receiving the third request, randomly selecting an individual high-risk WL of the current set of high-risk WLs; and determining whether the selected adjacent WL of the additional set of WLs or the selected individual high-risk WL triggers the read error handling operation.

Example 15: The system of any of Examples 1-14, the operations comprising in response to determining that the selected adjacent WL of the additional set of WLs or the selected individual high-risk WL triggers the read error handling operation, selecting a new set of physical storage locations comprising a set of data stored in the additional set of WLs adjacent to the third WL, the third WL, and the current set of high-risk WLs to include as part of a third portion of data that is folded, and folding the third portion of the data stored in the BS.

Example 16: The system of any of Examples 1-15, wherein folding the first portion of the data comprises performing an individual physical-to-logical (P2L) folding operation.

Example 17: The system of any of Examples 1-16, wherein each of the plurality of additional folding operations comprises performing an additional physical-to-logical (P2L) folding operation.

Example 18: The system of any of Examples 1-17, wherein the memory device comprises a three-dimensional (3D) NAND device.

Example 19: At least one non-transitory machine-readable storage medium comprising instructions that, when executed by a processing device, cause the processing device to perform operations comprising receiving a first request to read data from a first word line (WL) of a block stripe (BS) stored on a memory device; determining that the request to read the data triggers a read error handling operation; in response to determining that the request to read the data triggers the read error handling operation, folding a first portion of data stored in the BS including data stored in the first WL; and repetitively performing a plurality of additional folding operations for data remaining in the BS upon receiving additional requests to read data stored in the BS.

The term “coupled with” generally refers to a connection between components, which can be an indirect communicative connection or direct communicative connection (e.g., without intervening components), whether wired or wireless, including connections such as electrical, optical, magnetic, and the like.

“System data” hereinafter refers to data that is created and/or maintained by the memory sub-system for performing operations in response to host requests and for media management.

“User data”hereinafter generally refers to host data and garbage collection data.

“Read disturb” refers to a phenomenon where repeated read operations on a specific WL in a NAND flash memory block cause unintended changes in the threshold voltages of adjacent cells on unselected WLs within the same block. This effect can potentially lead to data corruption in neighboring cells if left unmanaged, necessitating periodic data refresh or block relocation (folding) operations to maintain data integrity in NAND-based storage devices.

“Folding” refers to an operation where data from multiple partially filled pages or blocks is combined and rewritten into a single page or block. This process helps to optimize storage space utilization, reduce write amplification, and improve overall performance of the NAND storage device by consolidating fragmented data and freeing up space for new writes. Folding and “relocation”operations are used interchangeably and mean the same thing.

“High-risk WLs” refer to WLs within a NAND flash memory block that are more susceptible to data corruption or errors due to various factors, such as frequent read operations, physical location within the block, and/or proximity to heavily accessed areas. These WLs can require more frequent monitoring, error checking, and potential data refresh or relocation operations to maintain data integrity and overall reliability of the NAND storage device. These WLs can be predetermined and stored as part of configuration data of the memory sub-system.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader scope of examples of the disclosure as set forth in the following claims. The specification and drawings are, accordingly, to be regarded in an illustrative sense rather than a restrictive sense.

1. A system comprising:
a memory device; and
a processing device, operatively coupled to the memory device, configured to perform operations comprising:
receiving a first request to read data from a first word line (WL) of a block stripe (BS) stored on the memory device;
determining that the request to read the data triggers a read error handling operation;
in response to determining that the request to read the data triggers the read error handling operation, folding a first portion of data stored in the BS including data stored in the first WL; and
repetitively performing a plurality of additional folding operations for data remaining in the BS upon receiving additional requests to read data stored in the BS.

2. The system of claim 1, wherein the read error handling operations comprise a read disturb handling (RDH) operation.

3. The system of claim 1, the operations comprising:
receiving a second request to read data from a second WL of the BS stored on the memory device; and
folding a second portion of data stored in the BS including data stored in the second WL without folding a third portion of data stored in the BS.

4. The system of claim 3, the operations comprising:
receiving a third request to read data from a third WL of the BS stored on the memory device; and
folding the third portion of data stored in the BS including data stored in the third WL.

5. The system of claim 1, the operations comprising:
determining a set of high-risk WLs within the BS based on historical read disturb data; and
adding the high-risk WLs in the first portion of data to be folded during the read error handling operation.

6. The system of claim 1, the operations comprising:
randomly selecting one of a set of adjacent WLs for each additional folding operation performed in response to the additional requests to read data stored in the BS.

7. The system of claim 1, the operations comprising:
selecting physical storage locations comprising data stored in a set of high-risk WLs within the BS, one or more adjacent WLs to the first WL, and the first WL to include as part of the first portion of data that is folded.

8. The system of claim 7, the operations comprising:
receiving a second request to read data from a second WL of the BS stored on the memory device;
in response to receiving the second request, randomly selecting an adjacent WL of a set of WLs adjacent to the second WL; and
determining whether the selected adjacent WL triggers the read error handling operation.

9. The system of claim 8, the operations comprising:
in response to determining that the selected adjacent WL triggers the read error handling operation, selecting additional physical storage locations comprising additional data stored in the set of WLs adjacent to the second WL and the second WL to include as part of a second portion of data that is folded; and
folding the second portion of the data stored in the BS.

10. The system of claim 8, the operations comprising:
reading one or more pages of data stored in the selected WL; and
determining that a read bit error rate (RBER) resulting from reading the one or more pages of data transgresses a threshold RBER.

11. The system of claim 7, the operations comprising:
receiving a second request to read data from a second WL of the BS stored on the memory device;
in response to receiving the second request, randomly selecting an adjacent WL of a set of WLs adjacent to the second WL;
in response to receiving the second request, randomly selecting a new high-risk WL of a new set of high-risk WLs; and
determining whether the selected adjacent WL or the selected new high-risk WL triggers the read error handling operation.

12. The system of claim 11, the operations comprising:
in response to determining that the selected adjacent WL or the selected new high-risk WL triggers the read error handling operation, selecting additional physical storage locations comprising additional data stored in the set of WLs adjacent to the second WL, and the second WL, and the new set of high-risk WLs to include as part of a second portion of data that is folded; and
folding the second portion of the data stored in the BS.

13. The system of claim 12, the operations comprising:
updating a current set of high-risk WLs remaining in portions of the BS that have yet to be folded.

14. The system of claim 13, the operations comprise:
receiving a third request to read data from a third WL of the BS stored on the memory device;
in response to receiving the third request, randomly selecting an additional adjacent WL of an additional set of WLs adjacent to the third WL;
in response to receiving the third request, randomly selecting an individual high-risk WL of the current set of high-risk WLs; and
determining whether the selected adjacent WL of the additional set of WLs or the selected individual high-risk WL triggers the read error handling operation.

15. The system of claim 14, the operations comprising:
in response to determining that the selected adjacent WL of the additional set of WLs or the selected individual high-risk WL triggers the read error handling operation, selecting a new set of physical storage locations comprising a set of data stored in the additional set of WLs adjacent to the third WL, and the third WL, the current set of high-risk WLs to include as part of a third portion of data that is folded; and
folding the third portion of the data stored in the BS.

16. The system of claim 1, wherein folding the first portion of the data comprises performing an individual physical-to-logical (P2L) folding operation.

17. The system of claim 16, wherein each of the plurality of additional folding operations comprises performing an additional physical-to-logical (P2L) folding operation.

18. The system of claim 1, wherein the memory device comprises a three-dimensional (3D) NAND device.

19. At least one non-transitory machine-readable storage medium comprising instructions that, when executed by a processing device, cause the processing device to perform operations comprising:
receiving a first request to read data from a first word line (WL) of a block stripe (BS) stored on a memory device;
determining that the request to read the data triggers a read error handling operation;
in response to determining that the request to read the data triggers the read error handling operation, folding a first portion of data stored in the BS including data stored in the first WL; and
repetitively performing a plurality of additional folding operations for data remaining in the BS upon receiving additional requests to read data stored in the BS.

20. A method comprising:
receiving a first request to read data from a first word line (WL) of a block stripe (BS) stored on a memory device;
determining that the request to read the data triggers a read error handling operation;
in response to determining that the request to read the data triggers the read error handling operation, folding a first portion of data stored in the BS including data stored in the first WL; and
repetitively performing a plurality of additional folding operations for data remaining in the BS upon receiving additional requests to read data stored in the BS.
